(19) United States
(12) Patent Application Publication
(10) Pub. No.: US 2011/0198764 A1
(43) Pub. Date: Aug. 18, 2011

(54) AERATION SYSTEM WITH ANTIMICROBIAL PROPERTIES

(75) Inventors: Willam S. Mitchell, McKenzie, TN (US); Erick Benjamin Williams, Austin, TX (US)

(73) Assignee: Tekni-Plex, Inc., King of Prussia, PA (US)

(21) Appl. No.: 13/030,832

(22) Filed: Feb. 18, 2011

Related U.S. Application Data
(60) Provisional application No. 61/305,725, filed on Feb. 18, 2010.

(51) Int. Cl. B01F 3/04; C02F 1/72; C02F 1/74; B29D 22/00

(52) U.S. Cl. 261/122.1; 210/758; 264/45.9; 210/764

(57) ABSTRACT

Aeration pipe for diffusion of a gas into a liquid medium, the pipe having a flexible microporous tubular wall of thermoset polymer particles and a thermoplastic binder for melt bonding said thermoset polymer particles and dispersing an antimicrobial compound substantially uniformly throughout the wall. The aeration pipe is useful in various environments such as aquaculture and waste water treatment.

### FIELD OF THE INVENTION

The present invention relates to an aeration pipe, e.g., for use in aquaculture (farming of aquatic species, including fish, clams, shrimp, etc.), waste water treatment, and the like, and to a method of manufacturing such aeration pipes.

### BACKGROUND OF THE INVENTION

It is known to impregnate surfaces with quaternary salts which have antimicrobial characteristics. For example, U.S. Pat. Nos. 6,146,688 and 6,572,926 disclose quaternary ammonium salts having the general formula

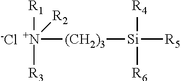

in which R₁ and R₂ are methyl groups, R₃ is octadecyl, and R₄, R₅ and R₆ are methoxy groups, for use in treating various products such as textiles, medical devices and supplies, to provide them with biocidal properties on their surfaces. These patents teach converting the methoxy groups to hydroxyl groups by hydrolysis, followed by polymerization through condensation of the hydroxy groups to form siloxane bonds. These patents are most particularly directed to the preparation of catheters, and teach polymerization of the quaternary salt after it has penetrated the surface of the host polymer.

U.S. Patent Publication Nos. 2006/0217515 and 2206/0223962 teach similar antimicrobial polymers with silicon-containing quaternary ammonium groups, which can be incorporated throughout a substrate or bound to its surface. These publications suggest use in a variety of products including films, paint, medical devices, building materials, toys, furniture, packaging and other articles.

In the field of aeration of water supplies, such as used in aquaculture (farming of any aquatic species, including fish, clams, shrimp, etc.) and waste water treatment, it is known to use a flexible porous aeration pipe. For example, U.S. Pat. No. 5,811,164 discloses an improvement on the conventional porous rubber hoses, made by an improved extrusion process. In accordance with the teachings of this patent, improved gas diffusion into a liquid medium such as water is accomplished using a pipe having a gas-permeable wall made of thermoset polymer particles melt bonded by a thermoplastic binder, and particularly one which includes a plurality of micropores of about 0.001 to about 0.004 inch average diameter along the length of the pipe for gas diffusion.

The search for better and longer lasting aeration devices has become increasingly important with the expansion of the fish farming and other water treatment markets.

### SUMMARY OF THE INVENTION

In accordance with one embodiment of the invention, an aeration pipe is provided for diffusion of a gas into a liquid medium, the pipe having a flexible microporous tubular wall of thermoset polymer particles and a thermoplastic binder for melt bonding said thermoset polymer particles and dispersing an antimicrobial compound substantially uniformly throughout the wall.

In one embodiment, the wall comprises a porous sponge-like structure with a multiplicity of interconnected irregular shaped pores.

In one embodiment, the microporous wall has an average diameter pore size in a range of from about 0.001 to about 0.004 inches.

In one embodiment, the particles comprise rubber.

In one embodiment, the rubber particles comprise at least 50 weight percent of the pipe.

In one embodiment, the binder comprises an ethylene polymer.

In one embodiment, the rubber particles have a mesh size of about 20 to 200 mesh.

In one embodiment, the pipe comprises from about 50% to about 90% by weight of rubber particles and from about 10% to about 50% by weight of thermoplastic binder.

In one embodiment, the thermoplastic binder comprises polyethylene.

In one embodiment, the polyethylene comprises low density polyethylene.

In one embodiment, the antimicrobial compound comprises a monomer or polymer with silicon-containing quaternary ammonium groups.

In one embodiment, the antimicrobial compound comprises a polymer containing silicon-containing quaternary ammonium groups.

In one embodiment, the microporous wall provides a gas flow rate in a range of 0.02-0.07 kilos of gas transferred per hour when submerged in a liquid medium.

In one embodiment, the liquid medium comprises an aquaculture, sewage treatment, or water purification medium.

In one embodiment, the liquid medium is an aquaculture medium.

In one embodiment, the gas is air or oxygen.

In accordance with another embodiment of the invention, a method of diffusing a gas into an aquaculture, sewage treatment or water purification medium is provided which includes submerging the aeration pipe into the medium and diffusing a gas into the medium.

In accordance with another embodiment of the invention, a method of manufacturing an aeration pipe for diffusion of a gas into a liquid medium is provided, the method including the steps of:
providing thermoset polymer particles, a thermoplastic binder for melt bonding said thermoset polymer particles, and an antimicrobial compound;
blending and extruding said thermoset polymer particles, said thermoplastic binder, and said antimicrobial compound to melt said binder and bind together said thermoset polymer particles and produce a gas diffusion pipe having a microporous wall with said antimicrobial compound substantially uniformly dispersed throughout said wall.

In one embodiment, the blending comprises first blending said thermoplastic binder with said antimicrobial compound, and subsequently blending said blend of said thermoplastic binder and said antimicrobial compound with said thermoset polymer particles.

In one embodiment, the blending comprises blending said thermoset polymer particles, said thermoplastic binder and said antimicrobial compound in a single step.

### BRIEF DESCRIPTION OF THE DRAWINGS

The present invention will be more fully appreciated with reference to the following detailed description and figures, in which:

FIG. 1A is a side sectional view of a portion of a microporous aeration pipe in accordance with one embodiment of the present invention; and FIG. 1B is a cross-sectional view of the pipe of FIG. 1A;

FIG. 2 is a top, elevational view of the exterior wall of the pipe of FIG. 1;

FIG. 3 is a top, elevational view of the aeration pipe of FIG. 1 for use in accordance with one embodiment of the invention;

FIG. 4 is a top, elevational view of an array of aeration pipes for use in accordance with another embodiment of the invention;

FIG. 5 shows one embodiment of the aeration pipes of the invention after 30 days use in fish farming, which pipes have remained substantially free of debris and unclogged;

FIG. 6 is a side, elevational view of the same aeration pipes, but without the antimicrobial compound, after 30 days use in the same environment, showing extensive surface debris and clogging of the pipes;

FIG. 7 is a block diagram of one method of manufacturing an aeration pipe according to one embodiment of the invention; and

FIG. 8 is a block diagram of another method of manufacturing an aeration pipe according to another embodiment of the invention.

### DETAILED DESCRIPTION

In one embodiment of the invention, a porous aeration pipe has a gas permeable wall of thermoset polymer particles bound together by a thermoplastic binder to form a flexible microporous wall having a pore size average diameter of about 0.001 inch to about 0.004 inch along its length for diffusion of gas through the wall and into a liquid medium. The micropores provide a substantially uniform porosity through the pipe wall along its length. The thermoset polymer particles preferably have a mesh size of about 20 to about 200 mesh, more preferably about 80 to 100 mesh. The particle mesh size and the resulting size of the micropores will affect the desired gas flow rate for a given application. An antimicrobial compound is substantially uniformly distributed throughout the wall as described further below.

The improved aeration pipe of the present invention can be made in accordance with an extrusion process of the type disclosed in U.S. Pat. No. 5,811,164, the disclosure of which is hereby incorporated by reference in its entirety. Prior to extrusion of the pipe, the specific antimicrobial compounds used in accordance with the invention are added to the extrudable mixture. These antimicrobial compounds may include for example the compounds of U.S. Pat. No. 6,572,926, and U.S. Patent Publication Nos. 2006/0223962 and 2006/0217515, the disclosures of each of which are incorporated herein by reference in their entirety.

In one embodiment, the antimicrobial compound employed in the aeration tubes of the present invention comprises a commercial product marketed by Biosafe, Inc. of Pittsburgh, Pa., USA, under the mark BIOSAFE HM 4100. The antimicrobial compound is added to the extrudable polymer mixture (i.e., the thermoset particles and thermoplastic binder) in the form of a fine polymeric powder with a size of up to about 200 mesh, preferably between about 180 and 220 mesh. This material readily blends with the polymeric materials disclosed in U.S. Pat. No. 5,811,164. The amount of antimicrobial material depends on the application; in various embodiments it may comprise between about 0.10% and 2% by weight, and more particularly between about 0.25% and 1% by weight. For cost savings a minimum effective amount is typically used; however, increasing the amount will increase the effectiveness of the antimicrobial.

While the commercial BIOSAFE material and like compounds have previously been used to impart antimicrobial activity onto the surface or into materials and products such as catheters, where the presence of microbes or bacteria can cause direct harm to patients and medical personnel handling these materials, such antimicrobial materials have not been previously used in connection with products such as a microporous aeration pipe, for diffusing gas into a liquid medium, as in the present invention. Their effective incorporation onto the thermoset particles, via the thermoplastic binder, is new, and has a significant effect not anticipated by prior uses of these compounds.

When using antimicrobial compositions in the present invention, one might assume the effective surface for killing microorganisms would quickly become covered with the dead organisms such as bacteria and algae, thus rendering ineffective the overall killing mechanism. As a result of losing its antimicrobial killing ability, one would expect the micropores to quickly clog (with algae and other microorganisms), preventing any further diffusion of the gas. However, when used in accordance with the present invention, these problems are overcome. With pipes made in accordance with the present invention, the antimicrobial has been effectively distributed in the rubber/binder matrix, so it does not leach and provides effective anti-microbial killing action in the microporous channels. Also, the overall surface of the pipe is constantly scoured and cleaned by the formation of the air bubbles and turbulence of the water on or around the tubular wall. As a result, the efficiency of the antimicrobial is increased and extended by use in connection with this product.

Thus, it has been discovered that the prevention of microbial and bacterial growth on the aeration tubes of this invention, and the reduction in the growth of various types of microorganisms, bacteria, algae, and the like, lengthens both the life and efficiency of these aeration pipes. The improvement in both product life and efficiency may be accomplished because the micropores in the wall of the aeration pipe are maintained without obstruction by such microorganisms, reducing the rate of clogging to a significant extent and increasing the efficiency of these products. The frequency of the need to clean these aeration products is significantly reduced, making the products much more commercially useful and cost effective.

In one embodiment, the porous pipe comprises thermoset polymer particles and a thermoplastic binder for binding the particles into a composite structure with a substantial volume of void space (the microporous channels). The pipe may be formed as an extrudable mixture in which a major portion comprises the thermoset polymer particles and a minor portion the thermoplastic binder. No further constituents (other than the antimicrobial compound) are required; however it may be desirable to include small amounts of slip agents or lubricants depending upon the process parameters. Examples of suitable thermoset polymer particles include natural or synthetic rubber. Cured crumb rubber reclaimed from the tread portions of vehicle tires, is readily available and an inexpensive source of the major component. The rubber may be ground into crumb like particles which are of a mesh size of about 20 to 200 mesh, and more specifically about 80 mesh to 100 mesh.

The binder component may be a thermoplastic resin material such as polyethylene (PE), and more particularly a linear low density polyethylene resin capable of thermal softening below about 300 degrees F., for extrusion processing with the crumb rubber particles in an extruder die that operates at a temperature ranging from about 350 to 365 degrees F. Other binders may be used, however PE is preferred since it is generally unreactive in water and soil environments over long-term use, and to various chemicals that may be used in the aeration application. Linear low density polyethylenes are known having a density ranging from about 0.90 to 0.93 gram per cubic centimeter, and porous pipe made from such binder resin is flexible and can be bent to desired configurations and contours. Polyethylene may be employed in the form of granules or particles having a fineness of about 40 mesh (0.0185 inch) to 0.125 inch.

The mixture may comprise about 50% to 90% by weight thermoset (e.g., crumb rubber) particles and about 50% to 10% by weight thermoplastic (e.g. polyethylene) binder resin, a particular embodiment being about 80% rubber particles and 20% polyethylene binder. Other particle sizes and weight percentages can be used depending on the porosity desired, the thickness, diameter and length of the pipe, the desired gas flow rate and other parameters of the intended application. In one embodiment of a pipe made from rubber particles and polyethylene binder, the outside diameter can range from 0.25 to 2.0 inch, with 1.0 inch being typical, and a wall thickness of 0.125 to 0.25 inch, typically 0.25 inch.

Typically, the thermoset particles and binder are intimately mixed prior to their introduction to the extruder, or may be delivered to the extruder through separate component hoppers. The components are mixed and heated within the extruder and passed therethrough by, e.g., a single screw having a continuous spiral flight. The mixture is thermally processed together, the binder being thermally softened and the crumb rubber particles remaining as discrete individual unmelted irregularly-shaped crumb particles. The particles are coated in part or completely by the binder during the mixing action of the extruder apparatus. The binder helps uniformly distribute the antimicrobial compound onto the thermoset particles, again by coating the particles. Optimally, the porous pipe exhibits a substantially uniform rate of delivery of the gas along its length (typically about 5-10 feet of pipe, per air input point).

A suitable extrusion apparatus for making a microporous pipe of crumb rubber particles and polyethylene according to one embodiment of the invention, is described in one or more of U.S. Pat. Nos. 5,811,038, 4,958,770, and 5,811,164.

The aeration pipe of the present invention comprises long tubular members having walls in the form of a porous sponge-like structure which contain a multiplicity of interconnected irregular shaped pores of such size, distribution and degree of interconnection that a gas within the pipe will diffuse through the wall, creating bubbles that spread out into a liquid medium surrounding the pipe.

By providing a plurality of elongated pores, whose major axis is at an acute angle to the longitudinal axis of the pipe, the outer surface and pores cooperate to give an extended surface distribution of the gas dispensed through the pipe. In performing the extrusion, the quantity and size of the ingredients is controlled relative to the extrusion conditions, e.g., temperature, pressure and speed of extrusion, to create walls in the tubing having a sponge-like structure of interconnected pores that create a desired rate of gas flow therethrough. The extruded tubing is then cut into lengths as desired, to form a porous pipe. A suitable coupling device is fixed to one end of the pipe to enable the pipe to be connected to a source of gas, such as a blower that feeds air into the pipe. The pressure of the air or oxygen in the pipe is typically low, e.g. ¼ psi. In one embodiment, the distal end of the tube is closed by a cap or the like.

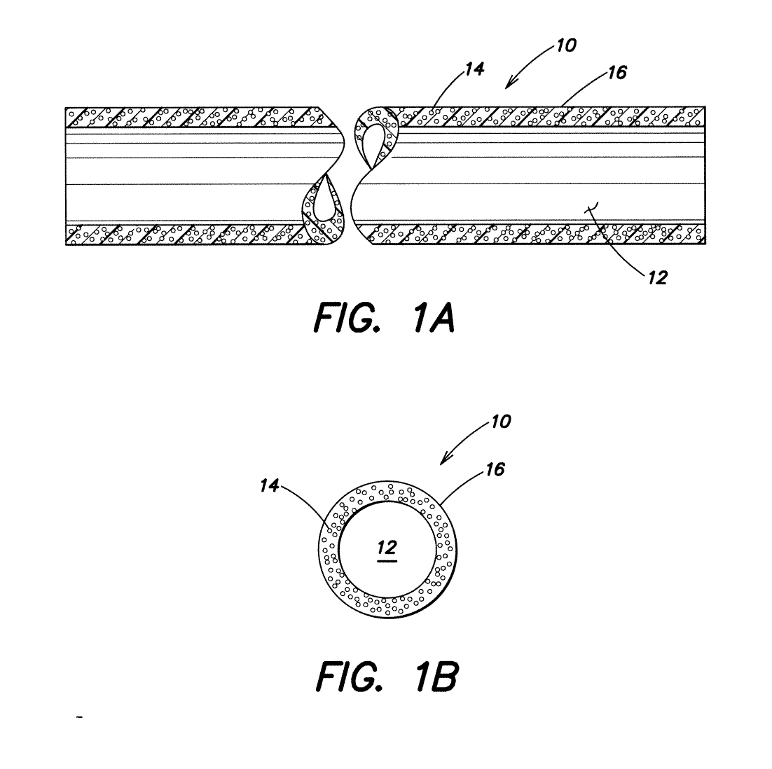

As shown in FIG. 1, the aeration pipe can be formed with a common circular cross section for optimizing mechanical strength. However other cross sectional shapes are possible, such as an elliptical cross section. The pipe may be used in a variety of configurations, e.g., straight runs, circles, grids or the like.

An aeration pipe according to one embodiment of the present invention is shown in FIG. 1. The aeration pipe 10 has a tubular configuration with an inner axial bore 12 through which is supplied a gas such as air or oxygen for bubbling through the interconnected micropores 14 in the tubular wall 16 of the aeration tube 10. In this example the pipe has a length of 6 feet, an outer diameter of 1.0±0.1 inch, a bore diameter of 0.5±0.1 inch, and thus a wall thickness of about 0.25 inch. The pipe is made from styrene-butadiene-rubber (SBR) (available from Edge Rubber, 811 Progress Road, Chambersburg, Pa., USA), LLDPE (available from Nova Chemicals Corp., Pittsburgh, Pa., USA), and HM4100 (available from Biosafe, Inc., Pittsburgh, Pa., USA).

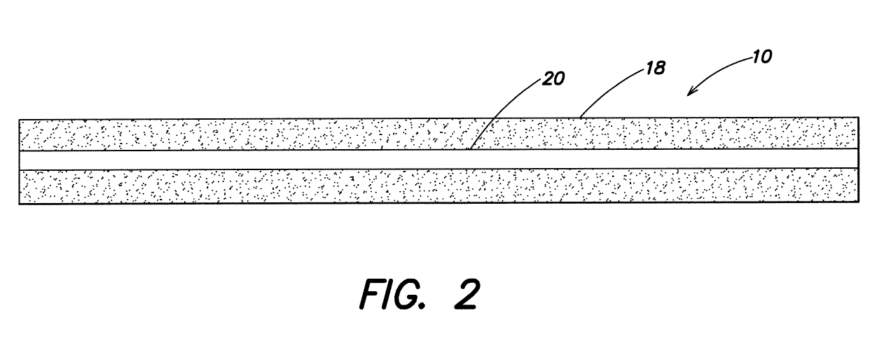

An exterior portion of the aeration tube 10 is shown in FIG. 2. In this example, a solid (nonporous) stripe 20 is provided along a lower portion of the outer surface 18 for positioning on a bottom surface of the tank or pond. The stripe 20 is an area where there are no micropores provided, since they would be unnecessary on the surface resting on a base or floor of a pond or other container of water which is to be aerated.

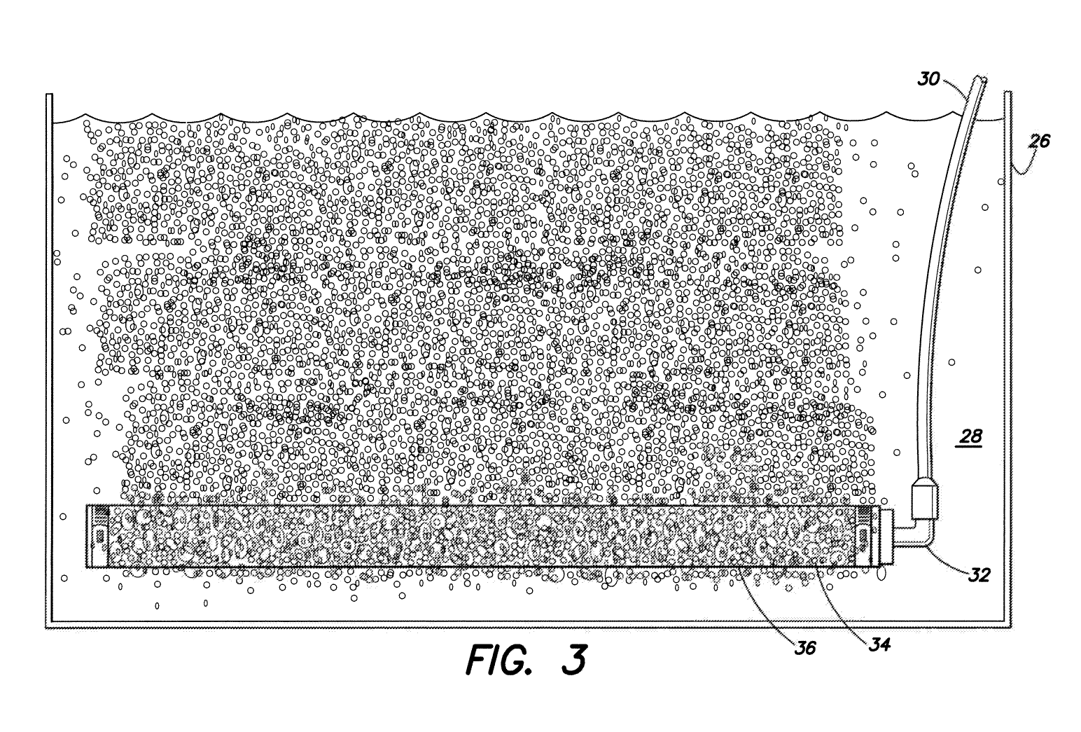

FIG. 3 illustrates one use of an aeration pipe. The pipe 34 is disposed in a tank 26 holding a liquid medium 28. A gas such as air is injected through entry tube 30 and fitting 32 into the interior of the pipe 34, and then passes through the microporous wall of the pipe, from which bubbles 36 are created for aeration purposes.

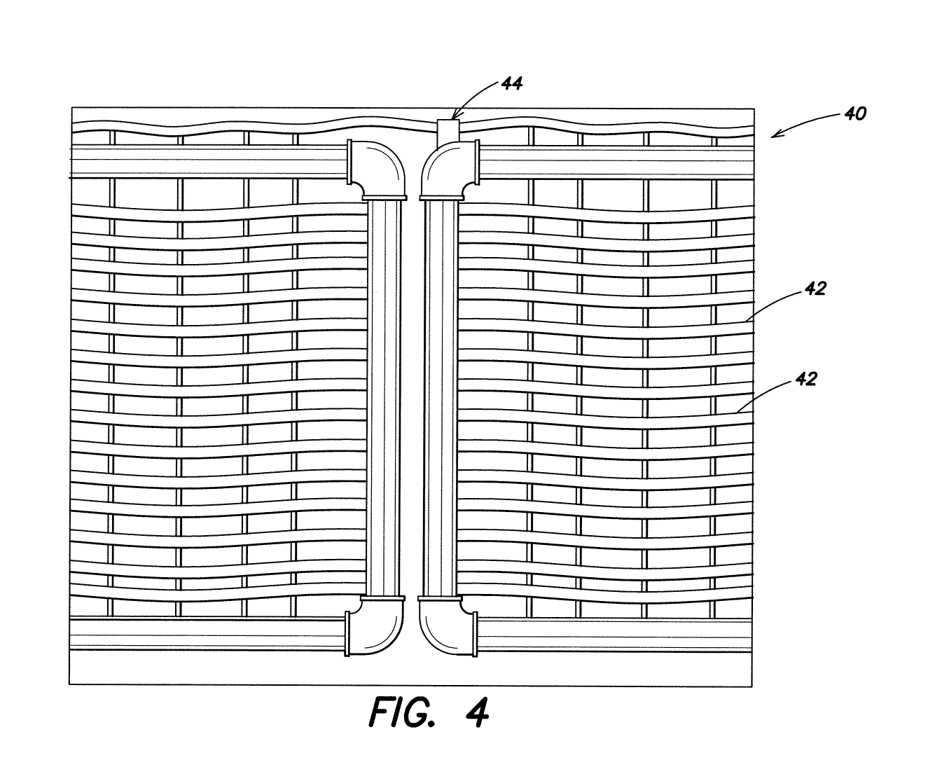

In accordance with another embodiment, shown in FIG. 4, a plurality of aeration pipes 42 form a grid or array 40. The plurality of parallel pipes 42 are attached to a supply conduit 44 which includes a corresponding number of fittings for each of the parallel pipes. Thus air can be injected into each of the pipes through the respective fitting to create an entire grid or array of pipes for aeration of a larger surface area.

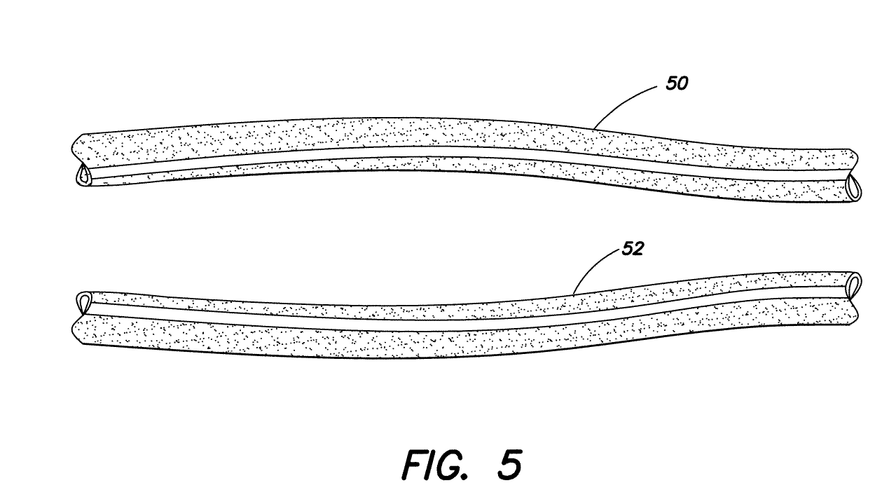

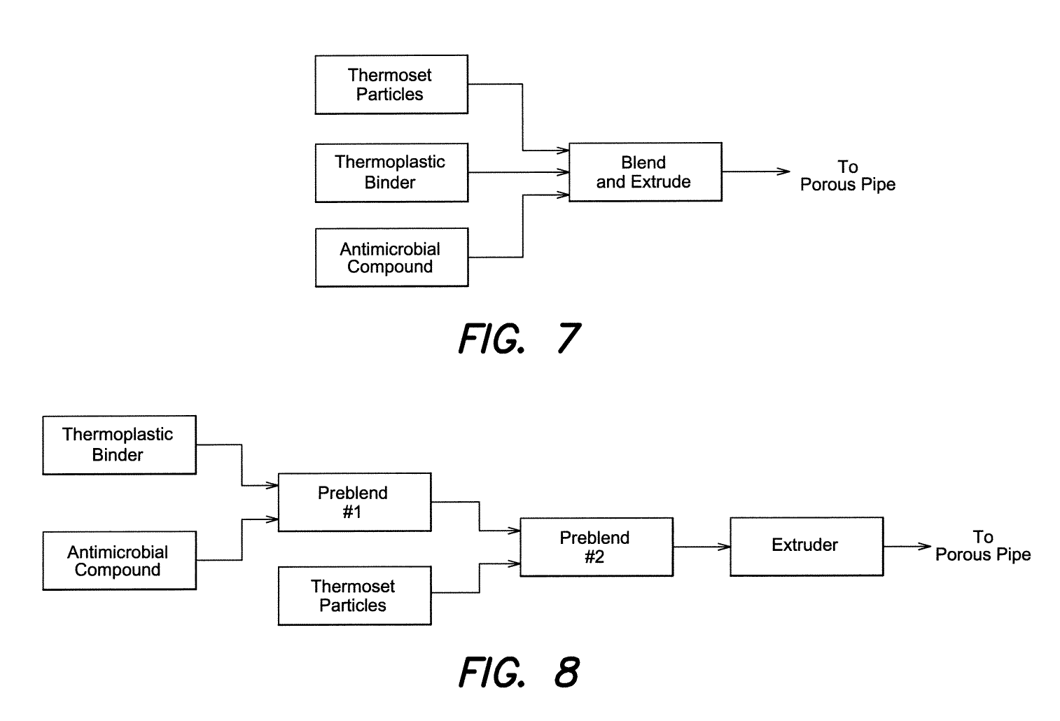

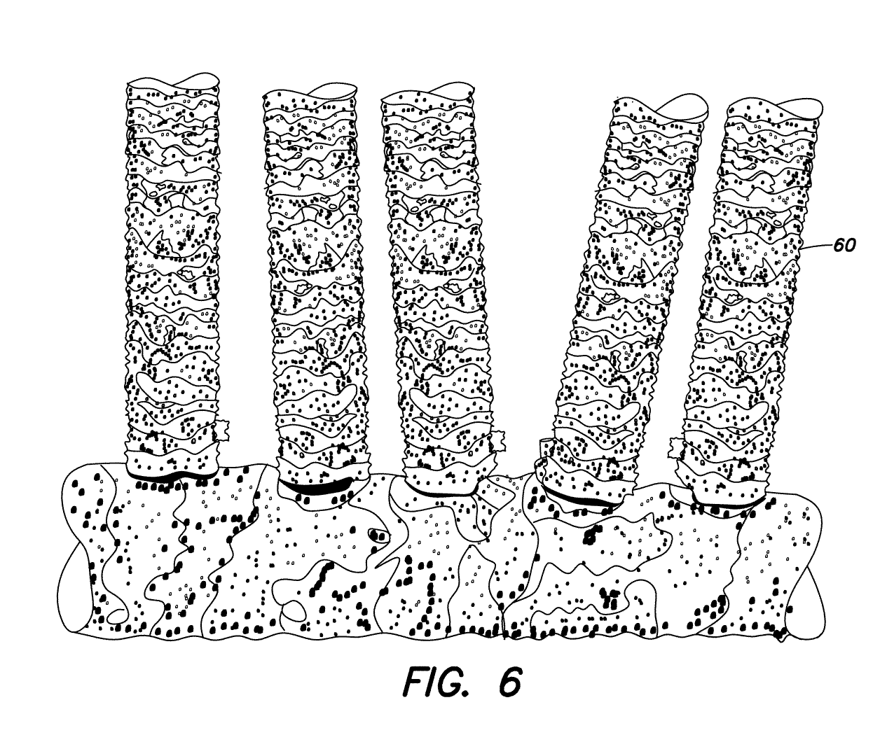

FIG. 5 shows two aeration pipes made in accordance with one embodiment of the invention, after use for a period of 30 days for aeration of a shrimp pond. The tubes 50, 52 are essentially in their original pristine condition, the micropores unclogged and substantially free of debris. In contrast, a number of the same pipes, but without the antimicrobial compound, are shown after the same use period in the shrimp pond in FIG. 6. These tubes 60 have clumps of attached algae, organisms and the like covering the tubes almost entirely, and blocking the pores.

A preferred antimicrobial silicon-containing quaternary ammonium salt for use in the present invention has the Formula I:

R₃N⁺R⁰ₙSiX₄₋ₙY

wherein each R and each R⁰ is independently, a non-hydrolysable organic group; each X is, independently, a hydrolysable group; n is an integer of 0 to 3; and Y is a suitable anionic moiety to form the salt of the compound of Formula I.

Preferably, each R and each R⁰ is independently a non-hydrolysable organic group, such as, without limitation, an alkyl group of 1 to about 22 carbon atoms or an aryl group, for example, phenyl; n is an integer of 0 to 3; each X is —OR′, wherein R′ is an alkyl group of 1 to about 22 carbon atoms, or an aryl group of 6 carbon atoms. More preferably, each of the R groups is independently methyl, ethyl, propyl, butyl, octyl, dodecyl, tetradecyl or octadecyl; each of the R⁰ groups is independently methylenyl, ethylenyl, propylenyl, butylenyl, octylenyl, dodecylenyl, tetradecylenyl or octadecylenyl; and each X is —OR′, wherein R′ is methyl, ethyl, propyl or butyl; and even more preferably, methyl or ethyl. Preferably, Y is a suitable anionic moiety to form the salt of the polymer of Formula I, such as halide, hydroxyl, acetate, SO₄⁻², CO₃⁻² and a PO₄⁻² counter ion. More preferably, Y is a halide.

One preferred antimicrobial compound for use in the present invention is a silicon-containing quaternary ammonium salt (shown below) where two of the Rs are methyl and one R is octadecyl, R⁰ is propylenyl, each X is a methoxy, n is 1 and Y is chloride, such that the quaternary ammonium salt is 3-(trimethoxysilyl)propyldimethyloctadecyl ammonium chloride.

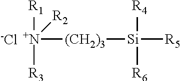

Generally, one exemplary process for making the aeration pipe of the present invention comprises extruding a plastic composition of thermoset particles, a thermoplastic binder and the antimicrobial compound at an elevated temperature through a die to form a softened pipe-preform. Gas may be injected under positive pressure into the inside of the softened pipe-preform during extrusion and cooling to produce a porous pipe of substantially constant size and shape having a fluid permeable wall along its length. The gas may be selected from the group consisting of air, oxygen, nitrogen, carbon monoxide and dioxide, argon and any inert gases not effecting the polymer matrix.

In a preferred form, the extruded thermoplastic composition comprises thermoset reclaimed rubber particles and a thermoplastic binder such as polyethylene for the particles. The composition is extruded through a heated die from about 350° F. to 365° F. to melt the polyethylene binder and form a pipe-preform in a very softened state. Gas is preferably injected through the center of the heated die and into the pipe-preform under a positive pressure of about 1/27 to about 3 psi and at a temperature sufficient to hold the pipe-preform in a substantially constant size and shape during the extrusion. Cooling the pipe-preform, preferably at temperatures below 200° F., while maintaining the positive gas pressure, solidifies the thermoplastic composition thereby creating a thin skin over the pipe within approximately 10 feet of cooling in a liquid or water bath approximately 48° F. to 52° F., and maintains a fluid permeable wall of the pipe-preform thereby producing a porous pipe of substantially uniform porosity throughout the wall thickness along its length. The thermoplastic binder is preferably a polyolefin or copolymer thereof, most preferably a linear low density polyethylene (LLDPE). Before mixing and introducing the composition into the extruder apparatus, the rubber particles preferably have a mesh size of about 20 to 200, and more preferably about 80 to 100 mesh.

The antimicrobial compositions as previously described are incorporated substantially uniformly throughout the porous pipe. This can be accomplished in a number of ways. For example, as illustrated in the block diagram of FIG. 7, all three components, the thermoset particles, thermoplastic binder, and antimicrobial compound can be blended and extruded to form the porous pipe.

Alternatively, as illustrated in FIG. 8, select components can be preblended, such as the thermoplastic binder and antimicrobial composition, prior to blending with the thermoset particles, and then the mixture delivered to the extruder to form the porous pipe. As a further alternative, all three components can be preblended together, and then delivered to the extruder.

In one example, the antimicrobial compound is added in a powdered form into a mixture of thermoset polymer particles, such as the above-described rubber particles, and the binder component. This dry blend can then be fed to an extruder for further processing. In a preferred embodiment, however, the antimicrobial compound is first compounded (melt blended) with the binder component, such as the polyethylene resin, and this mixture is then blended with the thermoset polymer particles, prior to feeding to the extrusion step.

The crumb rubber (thermoset polymer) polyethylene (binder), and antimicrobial compounds are preferably thoroughly dried prior to their introduction into the extruder, irrespective of the sequence in which they are compounded. The total moisture content of each component and the mixture is preferably maintained at a level below about 0.15% weight water prior to their combined use. Such low water content will assist in the development of small uniform pores in the pipe during and after extrusion. The non-homogeneity of the mixture and the proportions of the two components also serves to create uniform porosity in the pipe wall.

The mixture may comprise about 50% to 90% by weight crumb rubber particles and about 10% to 50% by weight polyethylene, preferably linear low density polyethylene, the preferred ratio being about 80% crumb rubber and 20% polyethylene by total weight.

The mixture is either combined and intimately mixed prior to its introduction into the extruder or delivered to the extruder through separate component hoppers affixed thereto. The mixture is further mixed and heated within the extruder and passed therethrough by a single-screw or a twin screw having a continuous spiral flight. The mixture is melted together, the binder being thermally softened and the crumb rubber particles remaining as discrete individual unmelted irregularly-shaped crumb particles. The particles are coated by the binder during the mixing and agitation action of the extruder apparatus, the lack of moisture assisting in the coating action.

The remainder of the extrusion process and apparatus is described in detail in U.S. Pat. No. 5,811,164, again the disclosure of which is incorporated herein by reference thereto.

As previously discussed, the aeration pipe of the present invention provides a significant improvement in efficiency by resisting clogging and maintaining a desired gas flow rate. For example, a desirable gas flow rate in an aquaculture environment may be in a range of 0.02-0.07 kilos of gas (e.g., oxygen) transferred to the liquid medium per hour. This measurement is made by submerging a 1 meter length of the aeration pipe into water, the water being substantially static, with no salinity, and no oxygen; an oxygen meter is then used to measure the rate of oxygen transferred to the water. One company that performs such measurements is GSEE Inc. (Environmental Services) of 599 Waldron Road, LaVergne, Tenn., USA.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the scope of the present invention as defined by the appended claims.

1. An apparatus comprising an aeration pipe for diffusion of a gas into a liquid medium, the pipe having a flexible microporous tubular wall of thermoset polymer particles and a thermoplastic binder for melt bonding said thermoset polymer particles and dispersing an antimicrobial compound substantially uniformly throughout the wall.

2. The apparatus of claim 1, wherein the wall comprises a porous sponge-like structure with a multiplicity of interconnected irregular shaped pores.

3. The apparatus of claim 1, wherein said microporous wall has an average diameter pore size in a range of from about 0.001 to about 0.004 inches.

4. The method of claim 1, wherein the particles comprise rubber.

5. The method of claim 4, wherein the rubber particles comprise at least 50 weight percent of the pipe.

6. The method of claim 5, wherein the binder comprises an ethylene polymer.

7. The method of claim 6, wherein the rubber particles have a mesh size of about 20 to 200 mesh.

8. The apparatus of claim 1, wherein said pipe comprises from about 50% to about 90% by weight of rubber particles and from about 10% to about 50% by weight of thermoplastic binder.

9. The apparatus of claim 6, wherein said thermoplastic binder comprises polyethylene.

10. The apparatus of claim 9, wherein said polyethylene comprises low density polyethylene.

11. The apparatus of claim 1, wherein said antimicrobial compound comprises a monomer or polymer with silicon-containing quaternary ammonium groups.

12. The apparatus of claim 1, wherein said antimicrobial compound comprises a polymer containing silicon-containing quaternary ammonium groups.

13. The apparatus of claim 1, wherein the microporous wall provides a gas flow rate in a range of 0.02-0.07 kilos of gas transferred per hour when submerged in a liquid medium.

14. The apparatus of claim 1, wherein the liquid medium comprises an aquaculture, sewage treatment, or water purification medium.

15. The apparatus of claim 14, wherein the liquid medium is an aquaculture medium.

16. The apparatus of claim 15, wherein the microporous wall provides a gas flow rate in a range of 0.02-0.07 kilos of gas transferred per hour when submerged in a liquid medium.

17. The apparatus of claim 1, wherein the gas is air or oxygen.

18. A method of diffusing a gas into an aquaculture, sewage treatment or water purification medium comprising submerging the pipe of claim 1 into the medium and diffusing a gas into the medium.

19. The method of claim 18, wherein the microporous wall provides a gas flow rate in a range of 0.02-0.07 kilos of gas transferred per hour when submerged in a liquid medium.

20. A method of manufacturing an aeration pipe for diffusion of a gas into a liquid medium, the method of comprising:
providing thermoset polymer particles, a thermoplastic binder for melt bonding said thermoset polymer particles, and an antimicrobial compound;
blending and extruding said thermoset polymer particles, said thermoplastic binder, and said antimicrobial compound to melt said binder and bind together said thermoset polymer particles and produce a gas diffusion pipe having a microporous wall with said antimicrobial compound substantially uniformly dispersed throughout said wall.

21. The method of claim 20, wherein said blending comprises first blending said thermoplastic binder with said antimicrobial compound, and subsequently blending said blend of said thermoplastic binder and said antimicrobial compound with said thermoset polymer particles.

22. The method of claim 20, wherein said blending comprises blending said thermoset polymer particles, said thermoplastic binder and said antimicrobial compound in a single step.
